(19) United States
(12) Patent Application Publication
(10) Pub. No.: US 2005/0259542 A1
(43) Pub. Date: Nov. 24, 2005

(54) Reproduction device and method, recording medium, and program

(76) Inventors: Teruhiko Mochizuki, Tokyo (JP); Yoshihiro Uchiumi, Kanagawa (JP); Toshichika Urushibara, Kanagawa (JP)

Correspondence Address: William S Frommer;Frommer Lawrence & Haug, 745 Fifth Avenue, New York, NY, 10151, US

(21) Appl. No.: 10/524,444

(22) PCT Filed: Jul. 2, 2003
(86) PCT No.: PCT/JP03/08393

§ 371 Date: Feb. 11, 2005

(30) Foreign Application Priority Data
Aug. 13, 2002 (JP) 2002-235764

(51) Int. Cl. G11B 5/09; G11B 7/00

(52) U.S. Cl. 369/53.2; 369/47.1; 369/53.1; 369/53.41; 369/59.1

(57) ABSTRACT

The present invention relates to a playback apparatus and method, which are capable of reading streaming data recorded on an information recording medium in compliance with an FAT scheme continuously without delay, to a recording medium for use therewith, and to a program therefor. In a DRAM for file playback information, file playback information generated by a CPU is stored. The file playback information is file playback information for playing back a file A generated on the basis of the FAT. In the file playback information, the cluster addresses of clusters used to record a corresponding file are recorded in sequence in the order in which they are used. In the file playback information of the file A, cluster addresses CL1, CL2, CL3, . . . , CL329, and CL330, in which files A-1 to A-18 forming the file A are recorded, are recorded, and an EOF is recorded following the cluster address CL330. The present invention can be applied to a hard disk recorder.

### TECHNICAL FIELD

The present invention relates to a playback apparatus and method, a recording medium, and a program. More particularly, the present invention relates to a playback apparatus and method, which are suitably used when a data file recorded on an information recording medium is to be played back in compliance with an FAT (File Allocation Table) scheme, to a recording medium for use therewith, and to a program therefor.

### BACKGROUND ART

Hitherto, as a format for recording a data file on an information recording medium such as a hard disk or playing it back, an FAT scheme has been known. The FAT scheme is supported as a standard in personal computers in which an OS (Operating System) such as MS-DOS and WINDOWS (registered trademark) is installed. Therefore, it may be said that the FAT scheme is the most widely used file format scheme.

The FAT method is described below. As shown in FIG. 1, the recording area of an information recording medium in compliance with the FAT scheme is divided into physical recording units called “sectors”. Each sector has a predetermined capacity (for example, 512 bytes) and is assigned a sector address. Access to the information recording medium is performed in units of sectors.

The recording area of the information recording medium is divided into logical recording units called “clusters” formed of a plurality of sectors (for example, 64 sectors). Each cluster is assigned a cluster address. Reading from and writing to the information recording medium are performed in units of clusters.

More specifically, when the size of a file to be recorded is larger than the capacity of one cluster, the file is divided into a plurality of clusters and is recorded. On the contrary, when the size of the file to be recorded is smaller than or equal to the capacity of one cluster, only the file concerned is recorded in one cluster.

At a predetermined address of the recording area, a file allocation table (hereinafter referred to as an “FAT”) that is referred to and updated when a file is read and written, and a directory entry are recorded.

In the FAT, a space corresponding to each of all the clusters of the information recording medium is provided. Therefore, the larger the capacity of the information recording medium, the larger the size of the FAT becomes. Each space of the FAT is assigned an FAT address.

In the space of FAT address 0, information indicating as to whether the cluster of the cluster address CL0 is vacant or is used is recorded. As the information indicating that it is used, when data that follows the data recorded in the cluster of the cluster address CL0 exists, the cluster address of the cluster, in which the data that follows is recorded, is recorded. When data that follows the data recorded in the cluster of the cluster address CL0 does not exist (that is, the file ends at the data recorded in the cluster of the cluster address CL0), an EOF is recorded as an end mark.

Similarly, in the spaces of the FAT addresses 1, 2, 3, . . . , information indicating that the clusters of the cluster addresses CL1, CL2, CL3, . . . are vacant or are used is recorded respectively.

In the directory entries, with regard to each file, the file name, the extension, attributes, the reserved area, the file creation time, the file creation date, the final access date, the updating date, the cluster address of the cluster in which the data of the start portion of the file concerned (hereinafter referred to as a “start cluster address”), and the file size are recorded.

The cluster address of the cluster in which the FAT is recorded, and the cluster address of the cluster in which the directory entry is recorded are contained in the management information that is recorded in the first one sector of the information recording medium. In the management information, also, the capacity of the information recording medium, and the information indicating as to how many sectors one cluster is formed of are contained.

The directory entries and the FAT are described below in more detail. It is assumed that, for example, as shown in FIG. 2, a file A is divided into files A-1 to A-18, and the files are recorded in the corresponding cluster addresses CL1, CL2, CL3, CL5, CL6, CL110, CL112, CL113, CL114, CL115, CL116, CL119, CL320, CL323, CL324, CL328, CL329, and CL330 of the information recording medium.

In this case, in the directory entry, as the start cluster address of the file A, the cluster address CL1 is recorded.

On the other hand, in the FAT, as shown in FIG. 3, in the space of the FAT address 1, the cluster address CL2 is recorded; in the space of the FAT address 2, the cluster address CL3 is recorded; and in the space of the FAT address 3, the cluster address CL5 is recorded. Although the description is omitted hereafter, finally, in the space of the FAT address 330, the EOF is recorded.

Next, a description is given of a process for a conventional reading apparatus to read the file A recorded on the information recording medium in the state shown in FIG. 2.

Initially, the directory entries of the information recording medium are referred to, and the start cluster address of the file A (in this case, the cluster address CL1) is read.

Next, the FAT recorded on the information recording medium is copied to a memory (DRAM (Dynamic Random Access Memory), etc.) contained in the reading apparatus. Since the capacity of the information recording medium is large, when the size of the FAT is larger than the size of the memory incorporated in the reading apparatus, a part of the FAT recorded on the information recording medium, the part containing a space corresponding to the cluster address of the cluster in which the beginning of the file A (the file A-1) is recorded (hereinafter referred to as a “partial FAT”), is copied to the memory inside the reading apparatus.

In the manner described above, the FAT is copied to the memory incorporated in the reading apparatus, and thereafter, the reading of the file A-1 is started from the cluster of the cluster address CL1. Then, concurrently with the reading of the file A-1, the FAT address 1 of the FAT of the incorporated memory is referred to, and the cluster address of the cluster in which the file A-2 is recorded (in this case, the cluster address CL2) is detected. After the reading of the file A-1 is completed, the reading of the file A-2 is started from the cluster of the cluster address CL2. Hereafter, similarly, the files A-3 to A-18 are also read.

As has thus been described, when a file is read, the FAT is referred to frequently. Therefore, in order that the time required for this referencing becomes as short as possible, the FAT copied to the memory incorporated in the reading apparatus is referred to.

Here, it is assumed that the file A recorded on the information recording medium in the state shown in FIG. 2 is stream data of an AV (Audio and Visual) signal coded by, for example, an MPEG-2 (Moving Pictures Experts Group 2) method. When the playback of this stream data while it is being read from the information recording medium is considered (processing such as decoding is performed, and the obtained video image is displayed on a display device and sound is output), unless the stream data is read quickly from the information recording medium, for example, the video image may be interrupted, or image loss and sound loss may occur.

First, a case in which playback is performed at a normal speed is considered. In the case of normal playback, as shown in FIG. 4, it is only necessary that, simply, by tracking the FAT in the forward direction, the cluster address of the cluster in which the next data is recorded is detected, and data is read from the cluster of the detected cluster address. The problem when normal playback is performed can occur when only a partial FAT can be copied to the incorporated memory due to the fact that the size of the FAT of the information recording medium is large.

It is assumed that, for example, a partial FAT that contains the FAT addresses 0 to 9 within the FAT shown in FIG. 4 and that does not contain the FAT address 110 is recorded. In this case, based on the cluster address CL110 recorded in the space of the FAT address 6, the file A-6 is read from the cluster of the cluster address CL110. In concurrence with that, even if an attempt is made to detect the next cluster address, a partial FAT containing the FAT address 110 corresponding to the cluster address CL110 is not yet copied into the memory. Therefore, there occurs the need to copy the partial FAT from the information recording medium to the incorporated memory. Due to such reasons, even when normal playback is performed, there is the problem in that a delay may occur in the reading of the data.

Next, a case in which fast forward playback is performed is considered. In the case of the fast forward playback, as shown in FIG. 5, it is necessary that, by tracking the FAT in the forward direction, the cluster address of the cluster in which the next data is recorded is detected, and data is read every several clusters (in the case of FIG. 5, every four clusters) in such a manner as to correspond to the fast forward speed.

The problem that occurs when fast forward playback is performed is that, because of the fast forward playback, the next cluster address must be searched for a plurality of times at a speed higher than that during normal playback. Furthermore, problems identical to those when the above-described normal playback is performed exist. Due to such reasons, when fast forward playback is to be performed, also, there is the problem in that a delay may occur in the reading of data.

Next, a case in which fast backward playback is performed is considered. When fast backward playback is to be is performed, as shown in FIG. 6, it is necessary that, by tracking the FAT in the reverse direction, the cluster address of the cluster in which the next data is recorded is detected, and data is read every several clusters (in the case of FIG. 6, every four clusters) in such a manner as to correspond to the fast backward speed.

The problem which occurs when fast backward playback is performed is caused by the fact that the tracking of the FAT in the reverse direction is more difficult than the tracking of the FAT in the forward direction. For example, in order to track the cluster address CL5 in the forward direction from the cluster address CL3, it is only necessary to refer to the space of the FAT address 3. In comparison, in order to track the cluster address CL3 in the reverse direction from the cluster address CL5, it is necessary to search for each space of the FAT and to specify the FAT address at which the cluster address CL3 is recorded.

Furthermore, also, when fast backward playback is to be performed, problems identical to those in the case where the above-described normal playback is performed, and problems identical to those in the case where the above-described fast forward playback is performed exist. Due to such reasons, also, when fast backward playback is performed, there is the problem in that a delay may occur in the reading of the data.

### DISCLOSURE OF THE INVENTION

The present invention has been made in view of such circumstances. An object of the present invention is to be capable of reading streaming data of an AV signal, etc., recorded on an information recording medium in compliance with the FAT scheme continuously without delay.

The playback apparatus of the present invention includes specification means for specifying a data file to be played back; storage means for reading and storing a first table recorded on the information recording medium; generation means for generating, based on the first table recorded by the storage means, a second table in which unit recording area addresses of the information recording medium, which are used to record the data file specified by the specification means, are recorded in the forward direction; holding means for holding the second table generated by the generation means; reading means for reading the data from the information recording medium in accordance with the specified unit recording area addresses; and indication means for indicating, to the reading means, the unit recording area addresses to be read by referring to the second table held by the holding means.

During normal playback, the indication means may read the unit recording area addresses, which are recorded in the second table, one-by-one in the forward direction, and may indicate the unit recording area addresses to the reading means.

During fast forward playback, the indication means may read the unit recording area addresses recorded in the second table every predetermined number of the unit recording area addresses in the forward direction, and may indicate the unit recording area addresses to the reading means.

During fast backward playback, the indication means may read the unit recording area addresses recorded in the second table every predetermined number of the unit recording area addresses in the reverse direction, and may indicate the unit recording area addresses to the reading means.

The playback method of the present invention includes a specification step of specifying a data file to be played back; a storage step of reading and storing a first table recorded on an information recording medium; a generation step of generating, based on the first table stored in the storage step, a second table in which unit recording area addresses of the information recording medium, which are used to record the data file specified in the specification step, are recorded in the forward direction; a holding step of holding the second table generated in the generation step; a reading step of reading the data from the information recording medium in accordance with the specified unit recording area addresses; and an indication step of indicating, to the reading step, the unit recording area addresses to be read by referring to the second table held in the holding step.

The program of the recording medium of the present invention includes a storage step of reading and storing a first table recorded on the information recording medium; a generation step of generating, based on the first table recorded in the storage step, a second table in which unit recording area addresses of the information recording medium, which are used to record the data file specified in the specification step are recorded in the forward direction; a holding step of holding the second table generated in the generation step; a reading step of reading the data from the information recording medium in accordance with the specified unit recording area addresses; and an indication step of indicating, to the reading step, the unit recording area addresses to be read by referring to the second table held in the holding step.

The program of the present invention enables a computer to perform processing including a storage step of reading and storing a first table recorded on the information recording medium; a generation step of generating, based on the first table recorded in the storage step, a second table in which unit recording area addresses of the information recording medium, which are used to record the data file specified in the specification step are recorded in the forward direction; a holding step of holding the second table generated in the generation step; a reading step of reading the data from the information recording medium in accordance with the specified unit recording area addresses; and an indication step of indicating, to the reading step, the unit recording area addresses to be read by referring to the second table held in the holding step.

In the playback apparatus and method, and the program of the present invention, the first table recorded on the information recording medium is read and stored. Based on the first stored table, a second table is generated in which unit recording area addresses of the information recording medium, which are used to record the specified data file, are recorded in the forward direction. Then, the unit recording area addresses to be read are indicated by referring to the second table. On the basis of the indication, the data file is read from the information recording medium.

The playback apparatus may be an independent apparatus or may be blocks for performing a recording/playback apparatus.

### BRIEF DESCRIPTION OF THE DRAWINGS

FIG. 1 shows sectors, which are physical recording units of an information recording medium, and clusters, which are logical recording units thereof.

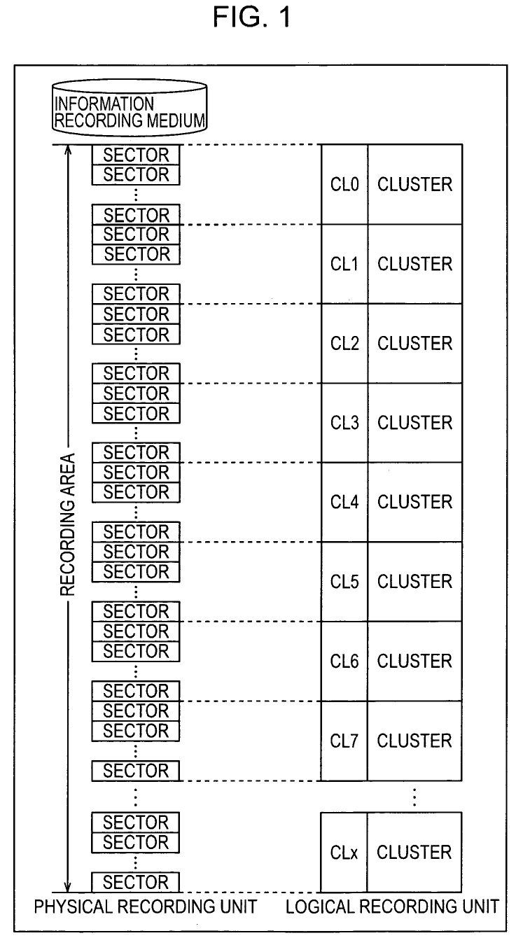

FIG. 2 shows a state in which a file is divided into a plurality of clusters and is recorded.

FIG. 3 shows an example of an FAT corresponding to the state shown in FIG. 2.

FIG. 4 illustrates a case in which normal playback is performed by referring to the FAT.

FIG. 5 illustrates a case in which fast forward playback is performed by referring to the FAT.

FIG. 6 illustrates a case in which fast backward playback is performed by referring to the FAT.

FIG. 7 is a block diagram showing an example of the configuration of an AV playback apparatus according to an embodiment of the present invention.

FIG. 8 shows file playback information generated on the basis of the FAT shown in FIG. 3.

FIG. 9 is a flowchart illustrating a playback pre-processing of the AV playback apparatus.

FIG. 10 illustrates a case in which normal playback is performed by referring to the file playback information.

FIG. 11 illustrates a case in which fast forward playback is performed by referring to the file playback information.

FIG. 12 illustrates a case in which fast backward playback is performed by referring to the file playback information.

### BEST MODE FOR CARRYING OUT THE INVENTION

A description will now be given, with reference to the drawings, of an AV playback apparatus, which is an embodiment of the present invention.

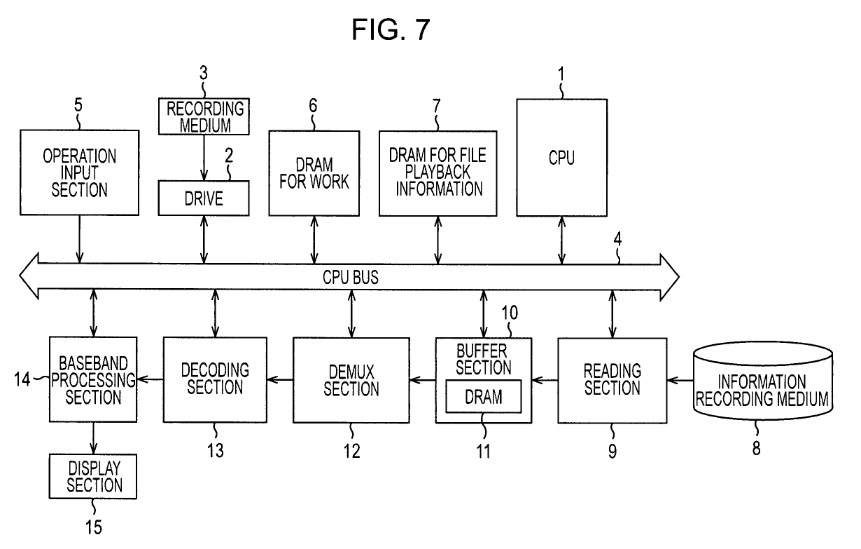

The AV playback apparatus is designed to be capable of reading streaming data of an AV signal recorded on an information recording medium 8 (FIG. 7) in compliance with the FAT scheme continuously without delay even in the case of normal playback, fast forward playback, or fast backward playback.

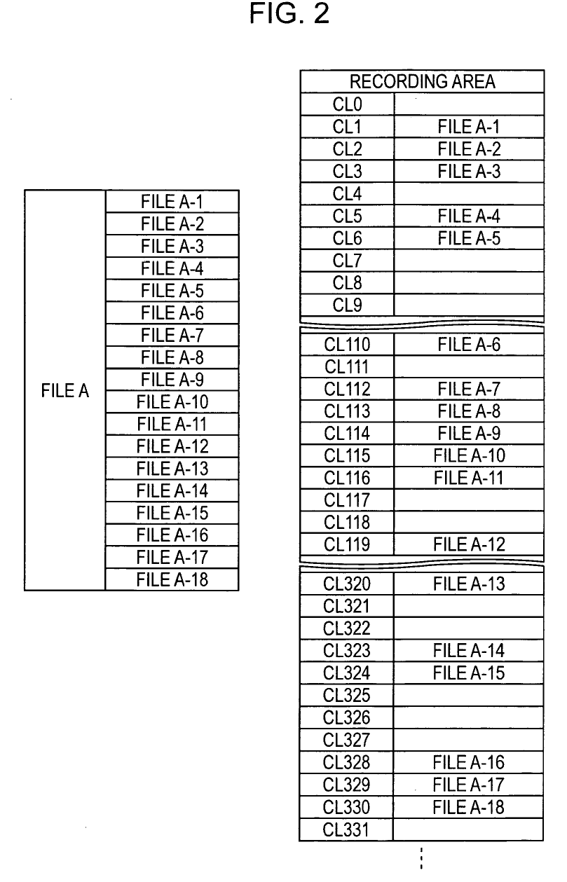

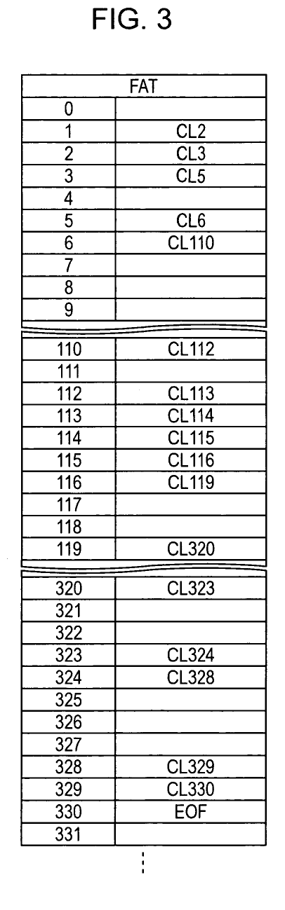

On the information recording medium 8 of the AV playback apparatus, a file A, which is the streaming data of an AV signal, is recorded in the state shown in FIG. 2. Furthermore, on the information recording medium 8, the FAT in the state shown in FIG. 3 containing the information regarding the file A recorded in the state shown in FIG. 2, is recorded.

FIG. 7 shows an example of the configuration of an AV playback apparatus. A CPU (Central Processing Unit) 1 controls a drive 2 via a CPU bus 4 in order to read a controlling program stored on a recording medium 3 formed of, for example, a magnetic disc, an optical disc, an optical magnetic disc, or a semiconductor memory, and to control the starting and ending of the operation of each section of the video playback apparatus in response to the read controlling program and the operation information of a user, which is input via the CPU bus 4 from an operation input section 5.

Furthermore, the CPU 1 generates file playback information on the basis of the FAT (or the partial FAT) copied from the information recording medium 8 to a DRAM 6 for work, and stores it in a DRAM 7 for file playback information. Hereafter, the process for generating the file playback information is referred to as a playback pre-processing.

In addition, during playback, the CPU 1 detects the cluster address of the cluster in which data to be read is written by referring to the file playback information of the DRAM 7 for file playback information, and transmits the cluster address together with the read command to a reading section 9 via the CPU bus 4.

A control signal between the CPU 1 and each section is communicated to the CPU bus 4. The communication of the streaming data, etc., among the sections is directly performed by the handshake method using an enable signal without being controlled by the CPU 1 or without the intervention of the CPU bus 4.

The operation input section 5 is formed of a user interface such as operation buttons. The operation input section 5 accepts an operation input from the user (an operation for turning on/off the power supply, an operation for specifying a file to be played back, an operation for instructing normal playback, an operation for instructing fast forward playback, an operation for instructing fast backward playback, etc.), and outputs it as operation information to the CPU 1 via the CPU bus 4.

The work DRAM 6 is a memory in which the FAT recorded on the information recording medium 8 is temporarily copied. The work DRAM 6 is also used as a work area when the CPU 1 generates file playback information on the basis of the copied FAT. When the size of the FAT recorded on the information recording medium 8 is larger than that of the work DRAM 6, a partial FAT is copied into the work DRAM 6.

In the DRAM 7 for file playback information, the file playback information generated by the CPU 1 is stored.

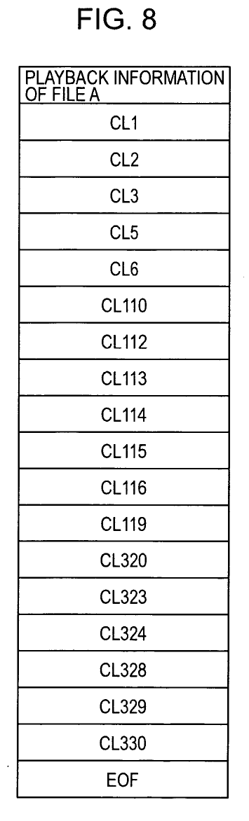

Here, the file playback information is described. FIG. 8 shows the file playback information generated to play back the file A on the basis of the FAT shown in FIG. 3.

In the file playback information, the cluster addresses of the clusters used to record the corresponding files are recorded in sequence in the order in which they are used. For example, as shown in FIG. 8, in the file playback information of the file A, cluster addresses CL1, CL2, CL3, . . . , CL329, CL330, at which the files A-1 to A-18 forming the file A are recorded, are recorded. Following the cluster address CL330, an EOF is recorded.

Here, the size of the DRAM 7 for file playback information for storing the file playback information is considered. In the FAT32 scheme, which is one type of the FAT scheme, the maximum size of one file is limited to 4 gigabytes. When one sector has 512 bytes, one cluster has 64 sectors, and the cluster address is represented by 4 bytes, the 4-gigabyte file is divided into 122071 (=4×10⁹/512×64) clusters and is recorded. Therefore, the file playback information generated in such a manner as to correspond to the 4-gigabyte file becomes approximately 480 (=122071×4) kilobytes long.

Therefore, in order that the file playback information corresponding to the 4-gigabyte file can be recorded, if the DRAM 7 for file playback information that has a size larger than or equal to 500 kilobytes is used, it is possible to deal with all the files.

Rather than separately providing the work DRAM 6 and the DRAM 7 for file playback information, a single DRAM may be provided so that it is divided into an work area corresponding to the work DRAM 6 and an area corresponding to the DRAM 7 for file playback information and is used.

Referring back to FIG. 7, the information recording medium 8 is formed of a hard disk formatted on the basis of the FAT scheme, and the directory entries and the FAT in addition to the file of an AV signal are recorded in a predetermined recording area thereof. The information recording medium 8 may be fixed to or removable from the AV playback apparatus.

Based on the read command input from the CPU 1 via the CPU bus 4, the reading section 9 reads data forming the directory entries, the FAT (or the partial FAT), or a file of an AV signal from the cluster address, specified by the CPU 1, of the information recording medium 8. The read directory entry is referred to by the CPU 1. The read FAT (or partial FAT) is stored in the work DRAM 6. The data forming the read file of the AV signal is buffered in a DRAM 11 of a buffer section 10.

The buffer section 10 incorporates the DRAM 11. The buffer section 10 supplies the data forming the file of the AV signal buffered in the DRAM 11, as streaming data, to a DEMUX section 12. Furthermore, the buffer section 10 requests the CPU 1 to read the data so as to maintain the state in which a predetermined amount of data is buffered in the DRAM 11. Here, as a result of the buffer section 10 being provided, even when the reading of the data of the AV signal is delayed, it is possible to compensate for the delay.

The DEMUX section 12 separates video coded data and audio coded data from the streaming data supplied from the buffer section 10, and outputs them to a decoding section 13. The decoding section 13 decodes the video coded data and the audio coded data, and outputs the obtained video signal and audio signal to a baseband processing section 14.

The baseband processing section 14 performs predetermined processing (for example, processing for conversion into an NTSC format) on the video signal input from the decoding section 13, and outputs it to a display section 15. Furthermore, the baseband processing section 14 performs a filtering process on the audio signal input from the decoding section 13 and outputs it to a speaker (not shown), etc. The display section 15 displays the video of the video signal input from the baseband section 14.

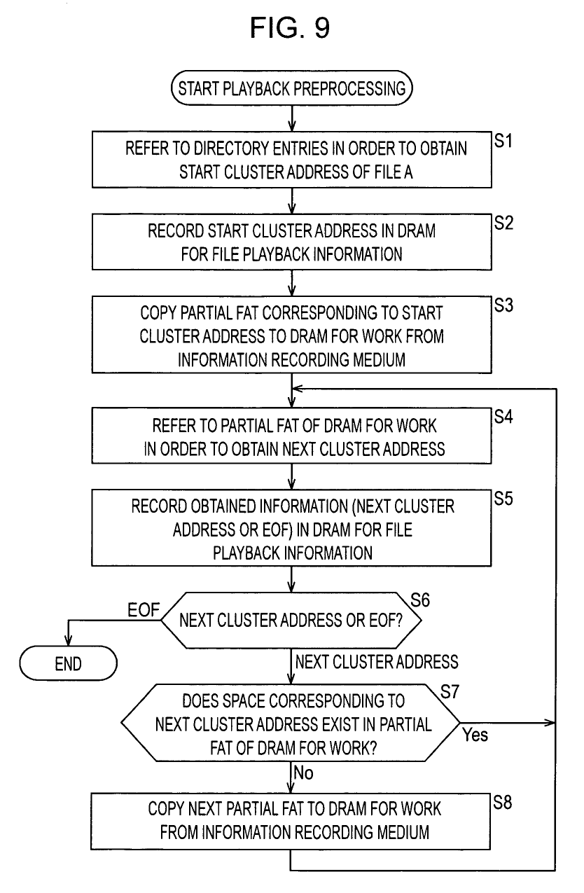

A description will now be given, with reference to FIG. 9, of the playback pre-processing of the AV playback apparatus. This playback pre-processing is started when a file to be played back is specified by a user (for example, the file A is specified).

In step S1, the CPU 1 controls the reading section 9 in order to read the directory entries of the information recording medium 8 and to obtain the start cluster address (in this case, the cluster address CL1) of the file A. Before the process of step S1 is performed, the directory entries of the information recording medium 8 may be copied in the work DRAM 6, so that the start cluster address of the file A is obtained from the directory entries of the work DRAM 6.

In step S2, the CPU 1 records the start cluster address CL1 of the file A obtained in the process of step S1 into the beginning of the file playback information of the file A generated in the DRAM 7 for file playback information.

In step S3, the CPU 1 controls the reading section 9 in order to copy, to the work DRAM 6 from the information recording medium 8, the partial FAT containing the FAT address 1 corresponding to the cluster address CL1 at the start of the file A. In this case, it is assumed that the partial FAT that contains the FAT addresses 0 to 9 and that does not contain the FAT address 110 and subsequent addresses is copied.

In step S4, the CPU 1 obtains the next cluster address following the start cluster address CL1 by referring to the partial FAT of the work DRAM 6. In this case, the FAT address 1 of the partial FAT is referred to, and the cluster address CL2 is obtained.

In step S5, the CPU 1 records the information obtained in the process of step S4 into the file playback information of the file A in the DRAM 7 for file playback information. In this case, the cluster address CL2 is recorded into the file playback information of the file A.

In step S6, the CPU 1 determines whether or not the information recorded in the process of step S5 is the next cluster address or the EOF. When it is determined that the information recorded in the process of step S5 is the next cluster address, the process proceeds to step S7. Conversely, when it is determined that the information recorded in the process of step S5 is the EOF, the playback pre-processing is completed.

In this case, since the information recorded in the process of step S5 is the next cluster address CL2, the process proceeds to step S7.

In step S7, the CPU 1 determines whether or not the FAT address corresponding to the next cluster address recorded in the process of step S5 exists in the partial FAT of the work DRAM 6. When it is determined that the FAT address corresponding to the next cluster address exists in the partial FAT of the work DAM6, the process returns to step S4, and processing of step S4 and subsequent steps is performed again. Conversely, when it is determined that the FAT address corresponding to the next cluster address does not exist in the partial FAT of the work DRAM 6, the process proceeds to step S8.

In this case, since the FAT address 2 corresponding to the next cluster address CL2 exists in the partial FAT of the work DRAM 6, the process returns to step S4, and processing of step S4 and subsequent steps is performed again.

In step S4 at the second time, the next cluster address CL3 is obtained. In step S5, the cluster address CL3 is recorded in the file playback information of the file A in the DRAM 7 for file playback information. In step S6, since it is determined that the information recorded in the process of step S5 is the next cluster address CL3, the process proceeds to step S7. In step S7, since the FAT address 3 corresponding to the next cluster address CL3 exists in the partial FAT of the work DRAM 6, the process returns to step S4, and processing of step S4 and subsequent steps is performed again.

Hereafter, similarly, processing of steps S4 to S7 is repeated three times. During this period, in the file playback information of the file A in the DRAM 7 for file playback information, the cluster addresses CL5 to CL110 are recorded.

In the process of step S7 at the fifth time, since it is determined that the FAT address 110 corresponding to the next cluster address CL110 recorded in the process of step S5 does not exist in the partial FAT of the work DRAM 6, the process proceeds to step S8.

In step S8, the CPU 1 controls the reading section 9 in order to copy, to the work DRAM 6 from the information recording medium 8, the partial FAT containing the FAT address corresponding to the next cluster address. In this case, it is assumed that the partial FAT that contains the FAT addresses 110 to 119 and that does not contain the FAT address 320 and subsequent addresses is copied.

Thereafter, the process returns to step S4, and processing of steps S4 to S7 is repeated seven times. During this period, in the file playback information of the file A in the DRAM 7 for file playback information, the cluster addresses CL112 to CL320 are recorded.

In the process of the subsequent step S7, since the FAT address 320 corresponding to the next cluster address CL320 recorded in the process of step S5 does not exist in the partial FAT of the work DRAM 6, the process proceeds to step S8.

In step S8 at the second time, it is assumed that the partial FAT containing the FAT addresses 320 to 330 is copied.

Thereafter, the process returns to step S4, and the above-described processing of steps S4 to S7 is repeated five times. During this period, in the file playback information file A in the DRAM 7 for file playback information, the cluster addresses CL323 to CL330 are recorded.

In the subsequent step S4, the space of the FAT address 330 of the partial FAT is referred to obtain the EOF. In step S5, the EOF is recorded in the file playback information of the file A in the DRAM 7 for file playback information. At this stage, the file playback information of the file A is completed in the DRAM 7 for file playback information. In step S6, since the information recorded in the process of step S5 is the EOF, the playback pre-processing is completed. This completes the description of the playback pre-processing.

The start timing of the playback pre-processing may be, rather than the time when the file to be played back is specified in the manner described above, when normal playback, fast forward playback, or fast forward playback is specified after the file to be played back is instructed.

The file playback information that is once generated in the DRAM 7 for file playback information is erased when the power supply is turned off or when another file is specified and the playback pre-processing is started. Therefore, to prevent this erasure, the file playback information may be stored in any non-volatile memory or in the information recording medium 8.

Next, the playback in which the file playback information of the DRAM 7 for file playback information is referred to is considered.

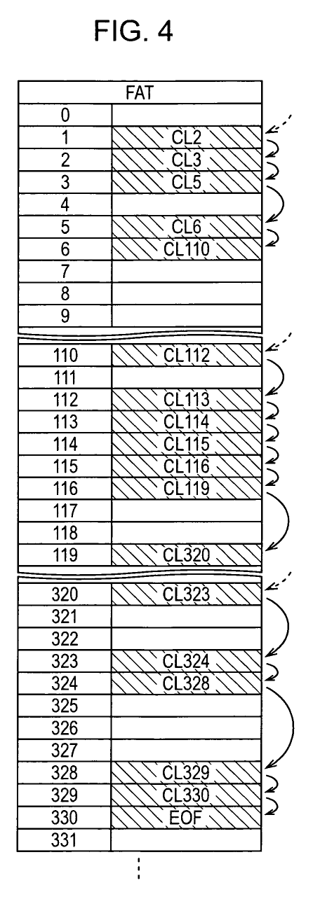

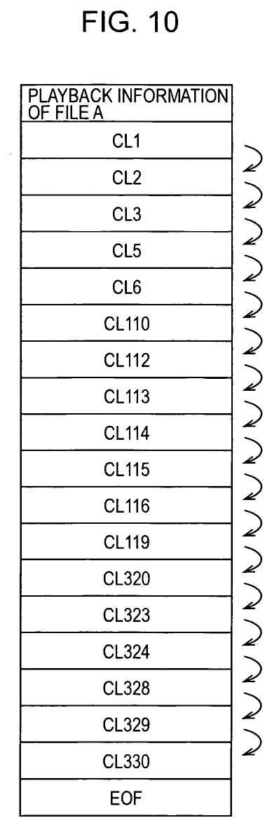

First, a case in which playback is performed at a normal speed is considered. When normal playback is instructed, as indicated by the arrow in FIG. 10, the CPU 1 reads the file playback information for each cluster address in the forward direction from the top toward the bottom, and notifies the read cluster address, together with the read command, to the reading section 9. In the file playback information of the file A, the cluster addresses of all the clusters, in which the files A-1 to A-18 forming the file A are recorded, are recorded in the forward direction of playback. Consequently, the problems when the partial FAT described with reference to FIG. 4 is used do not occur.

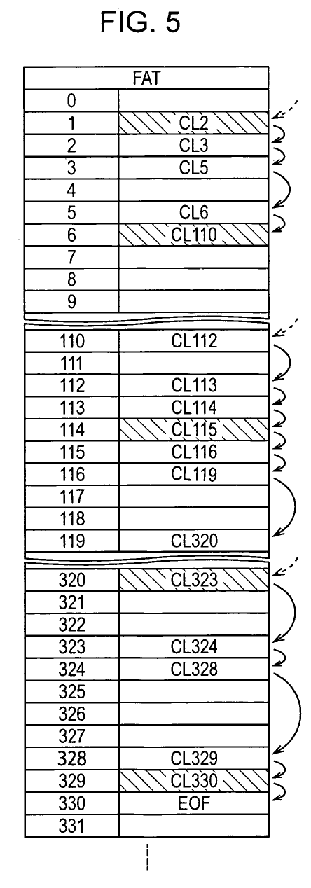

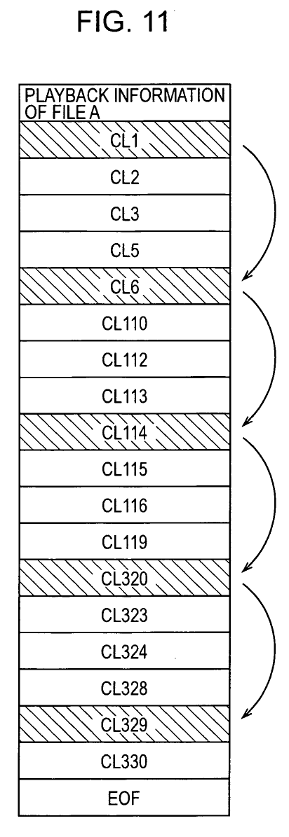

Next, a case in which fast forward playback is performed is considered. When fast forward playback is instructed, as indicated by the arrow in FIG. 11, the CPU 1 reads cluster addresses every several clusters of the file playback information in the forward direction from the top to the bottom, and notifies the read cluster addresses together with the read command to the reading section 9. The process for simply reading the cluster addresses every several clusters (in the case of FIG. 11, every four cluster addresses) from the file playback information in the forward direction from the top to the bottom in the manner described above is not a burden on the CPU 1. Therefore, the problems when the partial FAT described with reference to FIG. 5 is used do not occur.

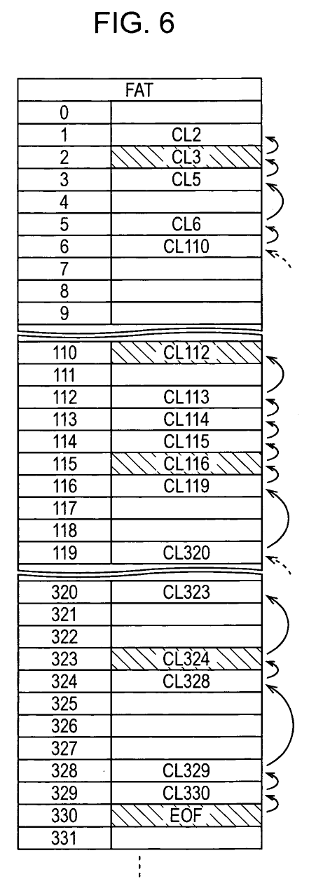

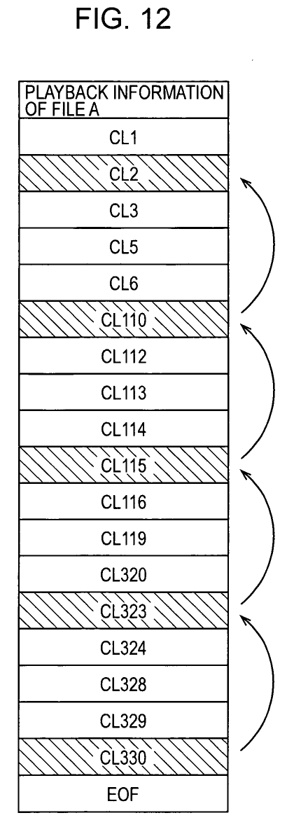

Next, a case in which fast backward playback is performed is considered. When fast backward playback is instructed, as indicated by the arrow in FIG. 12, the CPU 1 reads cluster addresses every several clusters from the file playback information in the reverse direction from the bottom to the top, and notifies the read cluster addresses together with the read command to the reading section 9. Also, the process for simply reading the cluster addresses every several clusters (in the case of FIG. 12, every four cluster addresses) from the file playback information in the reverse direction from the bottom to the top in the manner described above is not a burden on the CPU 1. Therefore, the problems when the partial FAT described with reference to FIG. 6 is used does not occur.

Therefore, if the file playback information of the DRAM 7 for file playback information is referred to, a delay does not occur in the reading of the data for any playback. Therefore, interruptions and losses do not occur in the played-back video and audio.

The present invention can be applied to, in addition to the AV playback apparatus, which is the embodiment of this invention, an AV recording/playback apparatus having a recording function.

The present invention can be applied to not only an apparatus for playing back the streaming data of an AV signal, but also an apparatus for reading other streaming data.

The present invention can be applied to an apparatus for recording any kind of data on an information recording medium formatted by the FAT scheme.

Although the series of processes described in the foregoing can be performed by hardware, it can also be executed by software. When the series of processes is performed by software, a program forming the software is installed from a recording medium (for example, the recording medium 3 of FIG. 7) into a computer (for example, the CPU 1 of FIG. 7) incorporated into dedicated hardware or into, for example, a general-purpose computer capable of executing various kinds of functions by installing various kinds of programs.

The recording medium is formed of a packaged medium formed of, for example, a magnetic disk (including a flexible disk), an optical disc (including a CD-ROM (Compact Disc-Read Only Memory) or a DVD (Digital Versatile Disc)), the magneto-optical disc (including an MD (Mini Disc)), or a semiconductor memory, in which programs are recorded, the recording medium being distributed to provide a program to a user separately from the computer. Furthermore, the recording medium is formed of a ROM, a hard disk drive, etc., in which programs are recorded, which are provided to the user by being preincorporated into the computer.

In this specification, steps for writing a program recorded on a recording medium may be executed chronologically according to the written orders. However, they do not have to be executed chronologically, and may be executed concurrently or individually.

### INDUSTRIAL APPLICABILITY

As has thus been described, according to the present invention, it is possible to read streaming data recorded on an information recording medium in compliance with the FAT scheme continuously without delay. Furthermore, according to the present invention, when the streaming data of an AV signal, etc., recorded on an information recording medium in compliance with the FAT scheme is to be played back at various speeds, it is possible that interruptions and losses do not occur in the video and audio.

1-7. (canceled)

8. A playback apparatus for playing back a data file recorded in a distributed manner on an information recording medium, said playback apparatus comprising:
specification means for specifying a data file to be played back;
storage means for reading and storing a first table recorded on said information recording medium;
generation means for generating, based on said first table recorded by said storage means, a second table in which unit recording area addresses of said information recording medium, which are used to record said data file specified by said specification means, are recorded in the forward direction;
holding means for holding said second table generated by said generation means;
reading means for reading said data file from said information recording medium in accordance with said specified unit recording area addresses every time at normal playback time, fast forward playback time, and fast backward playback time; and
indication means for indicating, to said reading means, said unit recording area addresses to be read by referring to said second table held by said holding means.

9. The playback apparatus according to claim 8, wherein, during normal playback, said indication means reads said unit recording area addresses, which are recorded in said second table, one-by-one in the forward direction, and indicates the unit recording area addresses to said reading means.

10. The playback apparatus according to claim 8, wherein, during fast forward playback, said indication means reads said unit recording area addresses recorded in said second table every predetermined number of the unit recording area addresses in the forward direction, and indicates the unit recording area addresses to said reading means.

11. The playback apparatus according to claim 8, wherein, during fast backward playback, said indication means reads said unit recording area addresses recorded in said second table every predetermined number of the unit recording area addresses in the reverse direction, and indicates the unit recording area addresses to said reading means.

12. A playback method for use with a playback apparatus for playing back a data file recorded in a distributed manner on an information recording medium, said playback method comprising:
a specification step of specifying a data file to be played back;
a storage step of reading and storing a first table recorded on said information recording medium;
a generation step of generating, based on said first table recorded in said storage step, a second table in which unit recording area addresses of said information recording medium, which are used to record said data file specified in said specification step, are recorded in the forward direction;
a holding step of holding said second table generated in said generation step;
a reading step of reading said data file from said information recording medium in accordance with said specified unit recording area addresses every time at normal playback time, fast forward playback time, and fast backward playback time; and
an indication step of indicating, to said reading step, said unit recording area addresses to be read by referring to said second table held in said holding step.

13. A recording medium having recorded thereon a computer-readable program for use with a playback apparatus for playing back a data file recorded in a distributed manner on an information recording medium, said program comprising:
a storage step of reading and storing a first table stored on said information recording medium;
a generation step of generating, based on said first table recorded in said storage step, a second table in which unit recording area addresses of said information recording medium, which are used to record said specified data file, are recorded in the forward direction;
a holding step of holding said second table generated in said generation step;
a reading step of reading said data file from said information recording medium in accordance with said specified unit recording area addresses every time at normal playback time, fast forward playback time, and fast backward playback time; and
an indication step of indicating, to said reading step, said unit recording area addresses to be read by referring to said second table held in said holding step.

14. A program for enabling a computer for controlling a playback apparatus for playing back a data file recorded in a distributed manner on an information recording medium to perform processing comprising:
a storage step of reading and storing a first table recorded on said information recording medium;
a generation step of generating, based on said first table stored in said storage step, a second table in which unit recording area addresses of said information recording medium, which are used to record said specified data file, are recorded in the forward direction;
a holding step of holding said second table generated in said generation step;
a reading step of reading said data file from said information recording medium in accordance with said specified unit recording area addresses every time at normal playback time, fast forward playback time, and fast backward playback time; and
an indication step of indicating, to said reading step, said unit recording area addresses to be read by referring to said second table held in said holding step.
